(19) United States
(12) Patent Application Publication
(10) Pub. No.: US 2021/0050596 A1
(43) Pub. Date: Feb. 18, 2021

(54) SOLID-STATE BATTERY HAVING AN ELECTRODE COMPRISING OF AN ELECTRONICALLY CONDUCTIVE POLYMER

(71) Applicant: GM Global Technology Operations LLC, Detroit, MI (US)

(72) Inventors: Zhe Li, Shanghai (CN); Haijing Liu, Shanghai (CN); Yong Lu, Shanghai (CN); Mengyan Hou, Shanghai (CN); Deween Kong, Shanghai (CN)

(21) Appl. No.: 16/817,012

(22) Filed: Mar. 12, 2020

(30) Foreign Application Priority Data
Aug. 16, 2019 (CN) 2019107573308

(51) Int. Cl. H01M 4/62; H01M 10/0525; H01M 10/0562; H01M 4/485; H01M 4/131

(52) U.S. Cl. CPC H01M 4/624; H01M 10/0525; H01M 10/0562; H01M 2300/008; H01M 4/131; H01M 2300/0071; H01M 4/485

(57) ABSTRACT

A solid-state battery cell for a lithium ion battery is disclosed. The battery cell includes a first electrode; a second electrode; and an ionically conductive layer sandwiched between the first electrode and the second electrode. At least one of the first electrode and the second electrode includes an electronically conductive polymer (ECP). The at least one of the first electrode and the second electrode comprises about 20-98 weight percent (wt %) of an active material, about 0.1-30 wt % of the ECP, and about 5-70 wt % of an ionically conductive material that includes one or more of a solid-state electrolyte (SSE) material and a lithium salt.

### INTRODUCTION

The present disclosure relates to rechargeable solid-state batteries and, more particularly, a solid-state battery having an electrode comprising of an electronically conductive polymer.

Rechargeable batteries are known to be used in consumer electronic applications from small electronic devices, such as cell phones to larger electronic devices such as laptop computers. Modern rechargeable lithium ion batteries have the ability to hold a relatively high energy density as compared to older types of rechargeable batteries such as nickel metal hydride, nickel cadmium, or lead acid batteries. A benefit of rechargeable lithium ion batteries is that the batteries can be completely or partially charged and discharged over many cycles without retaining a charge memory. In addition, rechargeable lithium ion batteries can be used in larger applications, such as for electric and hybrid vehicles due to the batteries' high power density, long cycle life, and ability to be formed into a wide variety of shapes and sizes so as to efficiently fill available space in such vehicles.

Modern rechargeable lithium ion batteries typically utilize organic liquid electrolyte to carry or conduct lithium cations (Li⁺) between a cathode active material and an anode active material. To further enhance battery performance, organic liquid electrolyte is replaced by solid-state electrolyte (SSE) in more modern batteries. Solid-state electrolytes could broaden the working temperature range and improve energy density of rechargeable lithium ion batteries. Rechargeable lithium ion batteries having solid-state electrolytes are known to be referred to as rechargeable solid-state lithium ion batteries.

For the majorities of known electrodes used in rechargeable solid-state lithium batteries, conductive carbon additives are utilized to obtain the desired electronic conduction pathways. However, it was found that the inclusion of carbon additives in the electrodes can stimulate the electrochemical decomposition of solid-state electrolyte, especially the sulfide-based solid-state electrolyte such as Li₁₀GeP₂S₁₂ (LGPS), and the decomposition products at the interface will lead to a large interfacial resistance and inferior kinetic performance.

Thus, while rechargeable solid-state lithium batteries achieve their intended purpose for use in electric and hybrid vehicles, there is a need for continuous improvement in the composition of the electrodes to obtain the desired electronic conduction pathways with minimal to no decomposition of the solid-state electrolyte (e.g. LGPS) at the interface.

### SUMMARY

According to several aspects, a battery cell is provided. The battery cell includes a first electrode, a second electrode, and an ionically conductive layer sandwiched between the first electrode and the second electrode. At least one of the first electrode and the second electrode includes an electronically conductive polymer (ECP).

In an additional aspect of the present disclosure, the ECP includes π-conjugated polymeric chains.

In another aspect of the present disclosure, the ECP includes at least one of a polypyrrole (PPy), a polyaniline (PANI), a polythiophene (PT), a poly(3,4-ethylenedioxy thiophene) (PEDOT), a poly(3,4-propylenedioxy thiophene) (PProDOT) and PEDOT:poly(4-styrene sulfonate) (PEDOT:PSS), polyacetylene (PA), and poly(p-phenylenevinylene) (PPV).

In another aspect of the present disclosure, the ECP can also be further modified by functional group, such as poly(3-hexylthiophene).

In another aspect of the present disclosure, at least one of the first electrode and the second electrode, further includes a solid-state electrolyte material.

In another aspect of the present disclosure, the solid-state electrolyte (SSE) material includes at least one of a sulfide-based SSE including a Li₂S—P₂S₅ system and lithium argyrodite Li₆PS₅X, wherein X=Cl, Br, or I; an oxide-based SSE including Li₇La₃Zr₂O₁₂; a polymer-based SSE including a polyethylene oxide (PEO) with LiTFSI, a nitride-based SSE including a LiSi₂N₃; a hydride-based SSE including LiBH₄—LiNH₂; a halide-based SSE including Li₃OCl, a borate-based SSE including Li₂O—B₂O₃—P₂O₅; an inorganic SSE/polymer-based hybrid electrolyte including Li₇La₃Zr₂O₁₂/polyvinylidene fluoride (PVDF)/Li salt hybrid solid electrolyte; and a surface-modified SSE including Indium (In)-deposited Li₇La₃Zr₂O₁₂.

In another aspect of the present disclosure, the battery cell further includes a liquid electrolyte permeating the first electrode, the ionically conductive layer, and the second electrode.

In another aspect of the present disclosure, at least one of the first electrode and the second electrode includes from about 20 weight percent (wt %) to about 98 wt % of an active material, from about 0.1 wt % to about 30 wt % of the ECP, and from about 5 wt % to about 70 wt % of a solid-state electrolyte (SSE) material.

In another aspect of the present disclosure, at least one of the first electrode and the second electrode includes from about 20 weight percent (wt %) to about 98 wt % of an active material, from about 0.1 wt % to about 30 wt % of the ECP, and from about 5 wt % to about 70 wt % of a lithium salt.

In another aspect of the present disclosure, the lithium salt includes a lithium cation and at least one of a hexafluoroarsenate; a hexafluorophosphate; a tris(pentafluoroethyl)-trifluorophosphate (FAP); a perchorate; a tetrafluoroborate; a trifluoromethanesulfonate (Triflate); a bis(fluorosulfonyl)amide (FSI); a cyclo-difluoromethane-1,1-bis(sulfonyl)imide (DMSI); cyclo-difluoromethane-1,1-bis(sulfonyl)imide (HPSI); a bis(trifluoromethanesulfonyl)imide (TFSI); a bis(perfluoroethanesulfonyl)imide (SETT); a bis(oxalate)borate (BOB); a difluoro(oxalato)borate (DFOB); a bis(fluoromalonato)borate (BFMB); a tetracyanoborate (Bison); a dicyanotriazolate (DCTA), a dicyano-trifluoromethyl-imidazole (TDI); a dicyano-pentafluoroethyl)-imidazole (PDI); and other anion.

According to several aspects, an electrode is provided. The electrode includes an electrode layer having from about 20 weight % (wt %) to about 98 wt % of an electrode active material; from about 5 wt % to about 70 wt % of an ionically conductive material; and from about 0.1 wt % to about 30 wt % of an electronically conductive polymer.

In an additional aspect of the present disclosure, the electronically conductive polymer includes at least one of a polypyrrole (PPy), a Polyaniline (PANI), a polythiophene (PT), a poly(3,4-ethylenedioxy thiophene) (PEDOT), a poly(3,4-propylenedioxy thiophene) (PProDOT) and PEDOT:poly(4-styrene sulfonate) (PEDOT:PSS), polyacetylene (PA), and poly(p-phenylenevinylene) (PPV).

In another aspect of the present disclosure, the electronically conductive polymer can also be further modified by functional group, such as poly(3-hexylthiophene).

In another aspect of the present disclosure, the ionically conductive material includes a solid-state electrolyte (SSE) material comprising at least one of a sulfide-based SSE, an oxide-based SSE, a polymer-based SSE, a nitride-based SSE, a hydride-based SSE, a halide-based SSE, a borate-based SSE, an inorganic/polymer-based Hybrid electrolyte, and a surface-modified SE.

In another aspect of the present disclosure, the ionically conductive material includes a lithium salt having a lithium cation and at least one of a hexafluoroarsenate; a hexafluorophosphate; a tris(pentafluoroethyl)-trifluorophosphate (FAP); a perchorate; a tetrafluoroborate; a trifluoromethanesulfonate (Triflate); a bis(fluorosulfonyl)amide (FSI); a cyclo-difluoromethane-1,1-bis(sulfonyl)imide (DMSI); cyclo-difluoromethane-1,1-bis(sulfonyl)imide (HPSI); a bis(trifluoromethanesulfonyl)imide (TFSI); a bis(perfluoroethanesulfonyl)imide (SETT); a bis(oxalate)borate (BOB); a difluoro(oxalato)borate (DFOB); a bis(fluoromalonato)borate (BFMB); a tetracyanoborate (Bison); a dicyanotriazolate (DCTA), a dicyano-trifluoromethyl-imidazole (TDI); a dicyano-pentafluoroethyl)-imidazole (PDI)); and other anion.

In another aspect of the present disclosure, the electrode active material includes a cathode active material including at least one of: a lithium manganese oxide (LiMn₂O₄); a lithium iron phosphate (LiFePO₄); a LiNi_{0.5}Mn₁₅O₄; a rock salt layered oxide including LiCoO₂, LiNiₓMn_{y}Co_{1-x-y}O₂, LiNiₓMn₁₋ₓO₂, Li₁₊ₓMO₂; a spinel such including LiMn₂O₄; a polyanion cathode including LiV₂(PO₄)₃; a coated or doped cathode material including LiNbO₃ coated LiNi_{0.5}Mn_{1.5}O₄

In another aspect of the present disclosure, the electrode includes of an anode active material including at least one of a carbonaceous material; a silicon; a silicon-graphite mixture; a lithium titanate (Li₄Ti₅O₁₂); a transition-metal; a metal oxide or metal sulfide including at least one of TiO₂, FeS, SnO₂; and a lithium-Indium (Li—In).

In another aspect of the present disclosure, the electrode further includes from greater than 0 wt % to about 15 wt % of an electronically conductive additive. The electronically conductive additive includes at least one of a carbon black, a graphite, a graphene, a graphene oxide, a Super P, an acetylene black, a carbon nanofiber, and a carbon nanotube.

In another aspect of the present disclosure, the electrode further includes from greater than 0 wt % to about 15 wt % of a binder, wherein the binder includes at least one of a poly(tetrafluoroethylene) (PTFE), a sodium carboxymethyl cellulose (CMC), a styrene-butadiene rubber (SBR), a poly(vinylidene fluoride) (PVDF), a nitrile butadiene rubber (NBR), a styrene ethylene butylene styrene copolymer (SEBS), and a styrene butadiene styrene copolymer (SBS).

According to several aspects, a battery having an electrode. The electrode includes from about 20 weight % (wt %) to about 98 wt % of an electrode active material; from about 5 wt % to about 70 wt % of an ionically conductive material; and from about 0.1 wt % to about 30 wt % of an electronically conductive polymer (ECP). The ionically conductive material includes at least one of a solid-state electrolyte material and a lithium salt. The ECP includes at least one of a polypyrrole (PPy), a polyaniline (PANI), a polythiophene (PT), a poly(3,4-ethylenedioxy thiophene) (PEDOT), a poly(3,4-propylenedioxy thiophene) (PProDOT) and PEDOT:poly(4-styrene sulfonate) (PEDOT:PSS), polyacetylene (PA), and poly(p-phenylenevinylene) (PPV).

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a rechargeable solid-state lithium ion battery cell having an electrode comprising of an electronically conductive polymer, according to an exemplary embodiment;

FIG. 2 is a diagrammatic representation of an exemplary electrode comprising of an electronically conductive polymer, according to an exemplary embodiment; and

FIG. 3 is a diagrammatic representation of a detailed portion of the electrode of FIG. 2, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

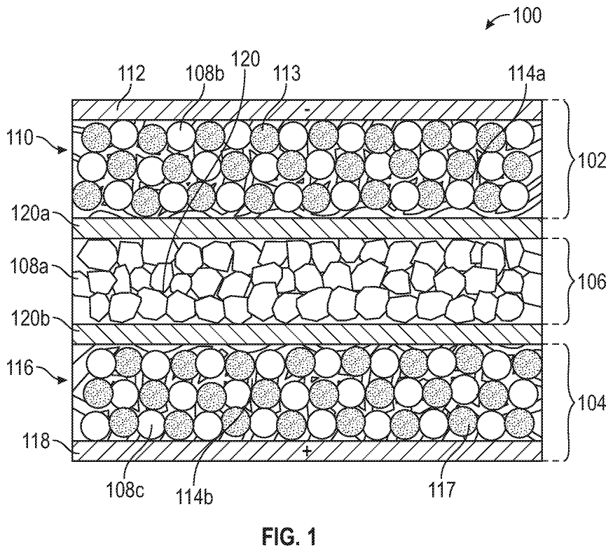

FIG. 1 shows an exemplary embodiment of a diagrammatic representation of a rechargeable solid-state lithium ion battery cell, generally indicated by reference number 100 (solid-state battery cell 100), having at least one electrode comprising of an electronically conductive polymer. The solid-state battery cell 100 includes a negative electrode 102, a positive electrode 104, and an ionically conductive layer 106 having a first ionically conductive material 108a disposed between the negative electrode 102 and the positive electrode 104. The negative electrode 102 is also referred to as an anode 102 and the positive electrode 104 is also referred to as a cathode 104. A plurality of the solid-state battery cells 100 may be folded or stacked to form a rechargeable solid-state lithium battery, and achieve a desired battery voltage, power and energy.

The negative electrode 102 includes an anode layer 110 and a negative current collector 112. The anode layer 110 is preferably formed of a second ionically conductive material 108b, an anode active material 113, and a first electronically conductive polymer 114a in intimate contact with the second ionically conductive material 108b and anode active material 113. The second ionically conductive material 108b may be the same as that of the first ionically conductive material 108a in the ionically conductive layer 106. Alternatively, the second ionically conductive material 108b may be different from that of the first ionically conductive material 108a in the ionically conductive layer 106.

The positive electrode 104 includes a cathode layer 116 and a positive current collector 118. The cathode layer 116 is preferably formed of a third ionically conductive material 108c, a cathode active material 117, a second electronically conductive polymer 114b in intimate contact with the third ionically conductive material 108c and cathode active material 117. The third ionically conductive material 108c may be the same as that of the first ionically conductive material 108a in the ionically conductive layer 106 or the second ionically conductive material 108b in the anode layer 110. Alternatively, the third ionically conductive material 108c may be different from that of the first ionically conductive material 108a in the ionically conductive layer 106 and that of the second ionically conductive material 108b in the anode layer 110.

Preferably the first, second, and third ionically conductive materials 108a, 108b, 108c possess a high ionically conductivity and low electronic conductivity, and exhibit a good chemical stability. Preferred ionically conductive material 108a, 108b, 108c includes one or more solid-state electrolyte materials selected from the following group of solid-state electrolytes (SSE):
Sulfide-based SSE, such as: Li₂S—P₂S₅, Li₂S—P₂S₅-MSₓ, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X=Cl, Br, or I), Li_{9.54}Si_{1.74}P_{1.44}S_{11.7}O_{10.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81} Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂;
Oxide-based SSE, such as: perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ(PO₄)₃ (LAGP), Li₁₊ₓYₓZr₂₋ₓ(PO₄)₃ (LYZP), LISICON type (Li₁₄Zn(GeO₄)₄), Garnet type (Li_{6.5}La₃Zr_{1.75}Te_{0.25}O₁₂);
Polymer-based SSE, such as: the polymer host together with a lithium salt act as a solid solvent. polymer: PEO, PPO, PEG, PMMA, PAN, PVDF, PVDF-HFP, PVC;
Nitride-based SSE, such as: Li₃N, Li₇PN₄, LiSi₂N₃;
Hydride-based SSE, such as: LiBH₄, LiBH₄—LiX (X=Cl, Br or I), LiNH₂, Li₂NH, LiBH₄—LiNH₂, Li₃AlH₆;
Halide-based, such as: LiI, Li₂CdCl₄, Li₂MgCl₄, Li₂Cdl₄, Li₂Znl₄, Li₃OCl
Borate-based SSE, such as: Li₂B₄O₇, Li₂O—B₂O₃—P₂O₅;
Inorganic SSE/polymer-based hybrid electrolyte such as Li₇La₃Zr₂O₁₂/polyvinylidene fluoride (PVDF)/Li salt hybrid solid electrolyte; and
Surface-modified/doped SSE such as Indium (In)-deposited Li₇La₃Zr₂O₁₂

The solid-state battery cell 100 includes a first separator interlayer 120a disposed between the negative electrode 102 and the ionically conductive layer 106 such that first separator interlayer 120a is in direct intimate contact with both the negative electrode 102 and the ionically conductive layer 106. A second separator interlayer 120b is disposed between the positive electrode 104 and the solid-state electrolyte layer 106 such that the second separator interlayer 120b is in direct intimate contact with both the positive electrode 104 and the solid-state electrolyte layer 106.

The first and second separator interlayers 120a, 120b may be formed of one or more lithium ions (Li⁺) ionically conductive materials including, but are not limited to, one or more of a polymer-based material, an inorganic material, a polymer-inorganic hybrid, and a metal and/or metal oxide material. The polymer-based material includes one or more of a poly(ethylene glycol) methyl-ether acrylate mixed with Al₂O₃ and lithium bis(trifluoromethanesulfonyl)imide (LiTFSI), polyethylene oxide (PEO) with LiTFSI, poly(vinylidene fluoride) copolymer with hexafluoropropylene (PVDF-HFP)-based gel electrolyte. The inorganic material includes 70% Li₂S-29% P₂S₅-1% P₂O₅. The polymer-inorganic hybrid material includes a mixture of PEO, LiTFSI, and 75% Li₂S-24% P₂S₅-1% P₂O₅ (LPOS) in mol %. The metal and metal oxide material include one or more of Nb, Al, Si and Al₂O₃.

While a first separator interlayer 120a and a second separator interlayer 120b are shown, an alternative embodiment of the solid state battery 100 may include only a single separator interlayer, which may be disposed between the negative electrode 102 and the ionically conductive layer 106 or disposed between the positive electrode 104 and the ionically conductive layer 106. Yet another alternative embodiment of the solid-state battery 100 may include no separator interlayers.

The solid-state battery cell 100 may include a liquid electrolyte permeating the anode layer 110, the ionically conductive layer 106, and the cathode layer 116 to aid in the facilitation of the transfer of lithium ions between the anode 102 and cathode 104. The liquid electrolyte 120 includes, but not limited to, ionic liquids such as Li (triethylene glycol dimethyl ether) bis(trifluoromethanesulfonyl)imide (Li(G3)TFSI)); carbonate-based electrolytes (such as LiPF₆-EC/DEC with additives), and concentrated electrolytes (such as LiTFSI in acetonitrile).

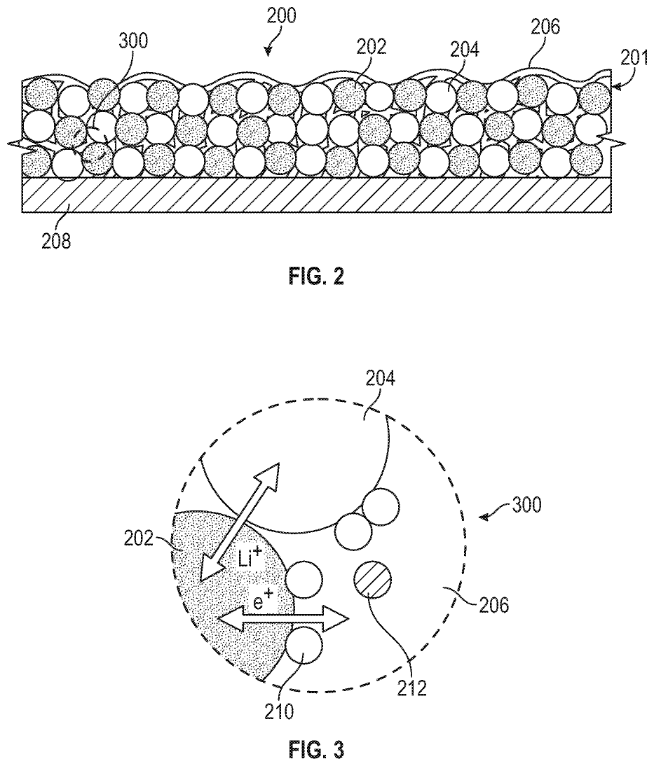

FIG. 2 is a diagrammatic representation of an exemplary solid-state lithium ion battery electrode 200 (electrode 200) having an electrode layer 201 comprising of an electrode active material 202, an ionically conductive material 204, and an electronically conductive polymer 206. The electrode 200 includes a current collector 208 in coextensive contact with the electrode layer 201. The electrode 200 may be that of the negative electrode 102 or that of the positive electrode 104 of the battery cell 100 of FIG. 1 depending on the composition of the electrode active material 202 in the electrode layer 201.

In one embodiment the electrode layer 201 comprising an electrode active material 202, a solid-state electrolyte material as the ionically conductive material 204, and an electronically conductive polymer 206. The weight percent (wt %) of the electrode active material 202 is in a range from about 20 wt % to about 98 wt %; the wt % of the solid electrolyte material is in a range of from about 5 weight wt % to about 70 wt %; and the wt % of the electronically conductive polymer 206 is in a range from about 0.1 wt % to about 30 wt %.

In another embodiment the electrode 200 comprises an electrode active material 202, a lithium salt as the ionically conductive material 204, and an electronically conductive polymer 206. The weight percent (wt %) of the active material is in a range of from about 20 wt % to about 98 wt %; the wt % of the lithium salt is in a range of from about 5 wt % to about 70 wt %; and the wt % of the electronically conductive polymer is in a range from about 0.1 wt % to about 30 wt %. The lithium salt includes a lithium cation and at least one of a hexafluoroarsenate; hexafluorophosphate; tris(pentafluoroethyl)-trifluorophosphate (FAP); perchorate; tetrafluoroborate, trifluoromethanesulfonate (Triflate); bis(fluorosulfonyl)amide (FSI); cyclo-difluoromethane-1,1-bis(sulfonyl)imide (DMSI); cyclo-difluoromethane-1,1-bis(sulfonyl)imide (HPSI), bis(trifluoromethanesulfonyl)imide (TFSI); bis(perfluoroethanesulfonyl)imide (SETT); bis(oxalate)borate (BOB); difluoro(oxalato)borate (DFOB); bis(fluoromalonato)borate (BFMB); tetracyanoborate (Bison); dicyanotriazolate (DCTA), dicyano-trifluoromethyl-imidazole (TDI); and dicyano-pentafluoroethyl)-imidazole (PDI); and other anion.

FIG. 3 is a detailed portion of the electrode 200 of FIG. 2 showing the interaction between the electrode active material 202, ionically conductive material 204, and electronically conductive polymer 206. Lithium ions (Li⁺) are shown moving between the electrode active material 202 and the ionically conductive material 204. Electrons (e−) are shown moving between the electrode active material 202 and the electronically conductive polymer 206. The electronically conductive polymer 206 provides a 3D electronically conductive network for electron transfer within the solid-state battery cell 100. Electronically conductive polymers are attractive organic materials due to their high electrical conductivity (up to 10³S/cm), easy processing, good affinity to many other materials, and controllable thickness and morphology. Representative electronically conductive polymers based on π-conjugated structures includes: polypyrrole (PPy), polyaniline (PANI), polythiophene (PT), poly(3,4-ethylenedioxy thiophene) (PEDOT), poly(3,4-propylenedioxy thiophene) (PProDOT) and PEDOT:poly(4-styrene sulfonate) (PEDOT:PSS), polyacetylene (PA), and poly(p-phenylenevinylene) (PPV). The electronically conductive polymer may be modified by other functional group, such as poly(3-hexylthiophene.

Electronically conductive additives 210 such as carbon black, graphite, graphene, graphene oxide, Super P, acetylene black, carbon nanofibers, and carbon nanotubes may also be added to further enhance the electronical conductivity of electrode 200. The wt % of electronically conductive additive 210 is in a range of from greater than 0 to about 15 wt %. Binders 212 such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS) may also be added into electrode 200 to further enhance the mechanical integrity of electrode. The wt % of binder is in a range of from greater than 0 to about 15 wt %.

Referring back to FIG. 2, in one exemplary embodiment, the electrode 200 is that of the negative electrode 102 of the solid-state battery cell 100 of FIG. 1. In this exemplary embodiment, the electrode layer 201 is an anode layer 110 having an anode active material 113, the ionically conductive material 204 is at least one of a solid-state electrolyte material 108b or a lithium salt, and the electronically conductive polymer 206 is a first electronically conductive polymer 114a, and the current collector 208 is a negative current collector 112. The anode layer 110 includes a thickness of between about 1 micrometer and about 1000 micrometers. The negative current collector 112 includes a thickness of between about 4 micrometers and about 100 micrometers. The negative current collector 113 is preferably a thin-film copper or nickel foil that coextensively contacts the anode active material 113, the solid-state electrolyte material 108b, and the electronically conductive polymer 114a in the negative electrode 102.

The anode active material 113 comprises a lithium host material that is capable of storing lithium at a lower electrochemical potential relative to the cathode active material 117. The anode active material 113 may include a carbonaceous material such as graphite, hard carbon, and soft carbon; silicon; silicon-graphite mixture; lithium titanate (Li₄Ti₅O₁₂); a transition-metal such as Sn; a metal oxide or metal sulfide such as TiO₂, FeS, SnO₂; and other lithium-accepting anode materials such as lithium-Indium (Li—In).

In another exemplary embodiment, the electrode 200 is that of the positive electrode 104 of the solid-state battery cell 100 of FIG. 1. In this embodiment, the electrode layer 201 is a cathode layer 116 having a cathode active material 117, the ionically conductive material 204 is at least one of a solid-state electrolyte material 108c or a lithium salt, the electronically conductive polymer 206 is a second electronically conductive polymer 114b, and the current collector 208 is a positive current collector 118. The cathode layer 116 includes a thickness of between about 1 micrometer and about 1000 micrometers. The positive current collector 118 includes a thickness of between about 4 micrometers and about 100 micrometers. The positive current collector 118 is preferably a thin-film aluminum foil that coextensively contacts the cathode active material 117, solid-state electrolyte material 108c, and the electronically conductive polymer 114b in the positive electrode 104.

The cathode active material 117 includes one or more lithium-based active material that is capable of storing intercalated lithium. Examples of such lithium-based active materials include Lithium manganese oxide (LiMn₂O₄); lithium iron phosphate (LiFePO₄); high-voltage oxides such as LiNi_{0.5}Mn_{1.5}O₄; coated and/or doped high-voltage cathode materials such as LiNbO₃-coated LiNi_{0.5}Mn_{1.5}O₄; rock salt layered oxides such as LiCoO₂, LiNiₓMn_{y}Co_{1-x-y}O₂, LiNiₓMn₁₋ₓO₂, Li₁₊ₓMO₂; spinel such as LiMn₂O₄; polyanion cathode such as LiV₂(PO₄)₃; and other lithium transition-metal oxides; and coated and/or doped cathode materials mentioned above.

Solid-state battery electrode designs that introduce electronically conductive polymers to replace traditional conductive carbon additives not only offers a necessary 3D electronically conductive framework and decrease the electrolyte degradation, but also function as binder materials to enable intimate contacts between solid components such as the active materials and solid-state electrolytes in the electrodes. The electronically conductive polymers also serve as a buffer layer tolerating the volume change of the active materials and enhances gravimetric energy density.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell, comprising:
a first electrode;
a second electrode; and
an ionically conductive layer sandwiched between the first electrode and the second electrode;
wherein at least one of the first electrode and the second electrode, comprises an electronically conductive polymer (ECP).

2. The battery cell of claim 1, wherein the ECP comprises a π-conjugated polymeric chain.

3. The battery cell of claim 2, wherein the ECP comprises at least one of a polypyrrole (PPy), a polyaniline (PANI), a polythiophene (PT), a poly(3,4-ethylenedioxy thiophene) (PEDOT), a poly(3,4-propylenedioxy thiophene) (PProDOT), PEDOT:poly(4-styrene sulfonate) (PEDOT:PSS), polyacetylene (PA), a poly(p-phenylenevinylene) (PPV), and a poly(3-hexylthiophene)

4. The battery cell of claim 1, further comprising a separator interlayer in direct intimate contact with the ionically conductive layer and one of the first electrode and the second electrode.

5. The battery cell of claim 1, wherein the at least one of the first electrode and the second electrode, further comprises a solid-state electrolyte material.

6. The battery cell of claim 5, wherein the solid-state electrolyte (SSE) material comprises at least one of a sulfide-based SSE including a Li₂S—P₂S₅ system and lithium argyrodite Li₆PS₅X, wherein X=Cl, Br, or I; an oxide-based SSE including Li₇La₃Zr₂O₁₂; a polymer-based SSE including a polyethylene oxide (PEO) with LiTFSI, a nitride-based SSE including a LiSi₂N₃; a hydride-based SSE including LiBH₄—LiNH₂; a halide-based SSE including Li₃OCl, a borate-based SSE including Li₂O—B₂O₃—P₂O₅; an inorganic SSE/polymer-based hybrid electrolyte including Li₇La₃Zr₂O₁₂/polyvinylidene fluoride (PVDF)/Li salt hybrid solid electrolyte; and a surface-modified SSE including Indium (In)-deposited Li₇La₃Zr₂O₁₂.

7. The battery cell of claim 6, further comprising a liquid electrolyte permeating the first anode, the ionically conductive layer, and the second anode.

8. The battery cell of claim 1, wherein the at least one of the first electrode and the second electrode comprises from about 20 weight percent (wt %) to about 98 wt % of an active material, from about 0.1 wt % to about 30 wt % of the ECP, and from about 5 wt % to about 70 wt % of a solid-state electrolyte (SSE) material.

9. The battery cell of claim 1, wherein the at least one of the first electrode and the second electrode comprises from about 20 weight percent (wt %) to about 98 wt % of an active material, from about 0.1 wt % to about 30 wt % of the ECP, and from about 5 wt % to about 70 wt % of a lithium salt.

10. The battery cell of claim 9, wherein the lithium salt comprises a lithium cation and at least one of a hexafluoroarsenate; a hexafluorophosphate; a tris(pentafluoroethyl)-trifluorophosphate (FAP); a perchorate; a tetrafluoroborate; a trifluoromethanesulfonate (Triflate); a bis(fluorosulfonyl)amide (FSI); a cyclo-difluoromethane-1,1-bis(sulfonyl)imide (DMSI); cyclo-difluoromethane-1,1-bis(sulfonyl)imide (HPSI); a bis(trifluoromethanesulfonyl)imide (TFSI); a bis(perfluoroethanesulfonyl)imide (BETI), a bis(oxalate)borate (BOB); a difluoro(oxalato)borate (DFOB); a bis(fluoromalonato)borate (BFMB); a tetracyanoborate (Bison); a dicyanotriazolate (DCTA), a dicyano-trifluoromethyl-imidazole (TDI); and a dicyano-pentafluoroethyl)-imidazole (PDI).

11. An electrode comprising:
an electrode layer having:
from about 20 weight % (wt %) to about 98 wt % of an electrode active material;
from about 5 wt % to about 70 wt % of an ionically conductive material; and
from about 0.1 wt % to about 30 wt % of an electronically conductive polymer.

12. The electrode of claim 11, wherein the electronically conductive polymer comprises at least one of a polypyrrole (PPy), a polyaniline (PANI), a polythiophene (PT), a poly(3,4-ethylenedioxy thiophene) (PEDOT), a poly(3,4-propylenedioxy thiophene) (PProDOT) and a PEDOT:poly(4-styrene sulfonate) (PEDOT:PSS), a polyacetylene (PA), a poly(p-phenylenevinylene) (PPV), and a poly(3-hexylthiophene).

13. The electrode of claim 12, wherein the electrode active material comprises a lithium transition-metal oxide.

14. The electrode of claim 12, wherein the ionically conductive material comprises a
solid-state electrolyte (SSE) material comprising at least one of a Sulfide-based SSE, an Oxide-based SSE, a Polymer-based SSE, a Nitride-based SSE, a Hydride-based SSE, a Halide-based SSE, a Borate-based SSE, an Inorganic SSE, a Polymer-based Hybrid electrolyte, and a Surface-Modified SE.

15. The electrode of claim 12, wherein the ionically conductive material comprises a lithium salt having a lithium cation and at least one of a hexafluoroarsenate; a hexafluorophosphate; a tris(pentafluoroethyl)-trifluorophosphate (FAP); a perchorate; a tetrafluoroborate; a trifluoromethanesulfonate (Triflate); a bis(fluorosulfonyl)amide (FSI); a cyclo-difluoromethane-1,1-bis(sulfonyl)imide (DMSI); cyclo-difluoromethane-1,1-bis(sulfonyl)imide (HPSI); a bis(trifluoromethanesulfonyl)imide (TFSI); a bis(perfluoroethanesulfonyl)imide (SETT); a bis(oxalate)borate (BOB), a difluoro(oxalato)borate (DFOB); a bis(fluoromalonato)borate (BFMB); a tetracyanoborate (Bison); a dicyanotriazolate (DCTA); a dicyano-trifluoromethyl-imidazole (TDI); a dicyano-pentafluoroethyl)-imidazole (PDI).

16. The electrode of claim 12, wherein the electrode active material comprises a cathode active material including at least one of:
a lithium manganese oxide (LiMn₂O₄); a lithium iron phosphate (LiFePO₄); a LiNi_{0.5}Mn_{1.5}O₄; a LiNbO3 coated LiNi_{0.5}Mn_{1.5}O₄; a rock salt layered oxide including LiCoO₂, LiNiₓMn_{y}Co_{1-x-y}O₂, LiNiₓMn₁₋ₓO₂, Li₁₊ₓ MO₂; a spinel such including LiMn₂O₄; and a polyanion cathode including LiV₂(PO₄)₃.

17. The electrode of claim 12, wherein the electrode comprises of an anode active material including at least one of a carbonaceous material; a silicon; a silicon-graphite mixture; a lithium titanate (Li₄Ti₅O₁₂); a transition-metal; a metal oxide or sulfide including at least one of TiO₂, FeS, SnO₂; and a lithium-Indium (Li—In).

18. The electrode of claim 12, further comprising:
from greater than 0 wt % to about 15 wt % of an electronically conductive additive, wherein the electronically conductive additive includes at least one of a carbon black, a graphite, a graphene, a graphene oxide, a Super P, an acetylene black, a carbon nanofiber, and a carbon nanotube.

19. The electrode of claim 12, further comprising:
from greater than 0 wt % to about 15 wt % of a binder, wherein the binder includes at least one of a poly(tetrafluoroethylene) (PTFE), a sodium carboxymethyl cellulose (CMC), a styrene-butadiene rubber (SBR), a poly(vinylidene fluoride) (PVDF), a nitrile butadiene rubber (NBR), a styrene ethylene butylene styrene copolymer (SEBS), and a styrene butadiene styrene copolymer (SBS).

20. A battery comprising an electrode, wherein the electrode includes:
from about 20 weight % (wt %) to about 98 wt % of an electrode active material;
from about 5 wt % to about 70 wt % of an ionically conductive material; and
from about 0.1 wt % to about 30 wt % of an electronically conductive polymer (ECP);
wherein the ionically conductive material includes at least one of a solid-state electrolyte material and a lithium salt; and
wherein the ECP comprises at least one of a polypyrrole (PPy), a polyaniline (PANI), a polythiophene (PT), a poly(3,4-ethylenedioxy thiophene) (PEDOT), a poly(3,4-propylenedioxy thiophene) (PProDOT) and PEDOT:poly(4-styrene sulfonate) (PEDOT:PSS), polyacetylene (PA), and poly(p-phenylenevinylene) (PPV).
